(19) United States
(12) Patent Application Publication
(10) Pub. No.: US 2026/0159356 A1
(43) Pub. Date: Jun. 11, 2026

(54) CONSTRUCTION ELEVATOR AND METHOD OF EXTENDING COMPENSATING ROPE FOR CONSTRUCTION ELEVATOR

(71) Applicant: Hitachi, Ltd., Tokyo (JP)

(72) Inventors: Yuto HINO, Tokyo (JP); Akitomo IGARASHI, Tokyo (JP); Katsunori NISHINO, Tokyo (JP); Masaki TASHIRO, Tokyo (JP); Hitoshi SUZUKI, Tokyo (JP)

(21) Appl. No.: 18/705,697

(22) PCT Filed: Nov. 12, 2021
(86) PCT No.: PCT/JP2021/041664

§ 371 Date: Apr. 29, 2024

(51) Int. Cl. B66B 7/06; B66B 9/00; B66B 11/00; B66B 19/00

(52) U.S. Cl. CPC B66B 7/068; B66B 9/00; B66B 11/004; B66B 19/00; B66B 7/064

(57) ABSTRACT

A construction elevator includes a compensating-rope reel; a rising/lowering unit; a pulley; a first rope-gripping device; and a second rope-gripping device. The pulley is disposed between the compensating-rope reel and the rising/lowering unit along the compensating rope, and the compensating rope drawn out from the compensating-rope reel is wound around the pulley. The first rope-gripping device releasably grips the compensating rope on a side of the compensating-rope reel with respect to the pulley. The second rope-gripping device releasably grips the compensating rope on a side of the rising/lowering unit with respect to the pulley. Furthermore, the pulley is movably supported along a rising/lowering direction of the rising/lowering unit.

### TECHNICAL FIELD

The present invention relates to a construction elevator and a method of extending a compensating rope of the construction elevator.

### BACKGROUND ART

In recent years, a construction elevator has been proposed as an elevator provided in a building structure under construction to transport materials and people. In this construction elevator, a machine room unit including a hoisting machine, a control panel, and the like is raised according to a progress status of construction of the building structure, whereby a range in which a car rises and lowers, that is, an operable range is expanded. In addition, the work of extending a main rope connected to the car is also performed along with the expansion of the range in which the car rises and lowers.

As a conventional construction elevator, for example, there is an elevator as described in Patent Literature 1. In a technique described in Patent Literature 1, when a machine room unit is raised, a gripping device grips a main rope with predetermined force in order to prevent the main rope from being drawn out of a main rope reel against the intention of an operator due to a weight of the main rope. Furthermore, by raising the machine room unit, the main rope slides on the gripping device and the main rope is extended.

In addition, in the construction elevator, a compensating chain for adjusting weight balance between the car and a counterweight when the car and the counterweight rise and lower is provided on the car and the counterweight. In addition, in an elevator for a long process, a compensating rope is adopted instead of a compensating chain from the viewpoint of strength.

Furthermore, it is necessary to extend the compensating rope along with the expansion of a range in which a car rises and lowers.

### Citation List

### Patent Literature

Patent Literature 1: JP 2001-287881 A

### SUMMARY OF INVENTION

### Technical Problem

However, in the case of the compensating rope, the compensating rope cannot be extended by adding unlike the compensating chain, and it is necessary to separately perform the work of lifting the machine room and the work of extending the compensating rope, and the work of extending the compensating rope is very complicated.

In consideration of the above problems, an object of the present invention is to provide a construction elevator and a method of extending a compensating rope of the construction elevator that allows the compensating rope to be easily extended.

### Solution to Problem

In order to solve the above problems and achieve the object, a construction elevator includes a compensating-rope reel, a rising/lowering unit, a pulley, at least one or more first rope-gripping devices, and at least one or more second rope-gripping devices. The compensating rope is wound around the compensating-rope reel. The compensating rope drawn out from the compensating-rope reel is wound around the rising/lowering unit, and the rising/lowering unit rises and lowers in a hoistway of a building structure. The pulley is disposed between the compensating-rope reel and the rising/lowering unit along the compensating rope, and the compensating rope drawn out from the compensating-rope reel is wound around the pulley. The first rope-gripping device releasably grips the compensating rope on a side of the compensating-rope reel with respect to the pulley. The second rope-gripping device releasably grips the compensating rope on a side of the rising/lowering unit with respect to the pulley. Furthermore, the pulley is movably supported along a rising/lowering direction of the rising/lowering unit.

In addition, a method of extending the compensating rope of the construction elevator having the above-described configuration includes the following steps (1) to (4).
(1) A step of gripping the compensating rope by the second rope-gripping device.
(2) A step of releasing the gripping of the compensating rope by the first rope-gripping device, raising the pulley to a predetermined height along the rising/lowering direction of the rising/lowering unit, and drawing out the compensating rope from the compensating-rope reel.
(3) A step of, after the pulley is raised to the predetermined height, gripping the compensating rope by the first rope-gripping device and releasing the gripping of the compensating rope by the second rope-gripping device.
(4) A step of raising a machine room unit provided with the second rope-gripping device to a predetermined height.

### Advantageous Effects of Invention

The construction elevator having the above configuration and the method of extending the compensating rope allows the compensating rope to be easily extended.

### BRIEF DESCRIPTION OF DRAWINGS

FIG. 1 is a schematic configuration diagram illustrating a construction elevator according to a first embodiment example.

FIG. 2 is a diagram illustrating a state of a gripping device during normal operation in the construction elevator according to the first embodiment example.

FIG. 3 illustrates a method of extending a compensating rope in the construction elevator according to the first embodiment example and is a diagram illustrating a state in which a pulley is moving.

FIG. 4 illustrates the method of extending the compensating rope in the construction elevator according to the first embodiment example and is a diagram illustrating a state in which a machine room unit is moving.

FIG. 5 is a diagram illustrating a state of the gripping device in the state illustrated in FIG. 4.

FIG. 6 illustrates the method of extending the compensating rope in the construction elevator according to the first embodiment example and is a diagram illustrating a state after the machine room unit moves.

FIG. 7 is a diagram illustrating a state of the gripping device in the state illustrated in FIG. 6.

FIG. 8 is a schematic configuration diagram illustrating a construction elevator according to a second embodiment example.

FIG. 9 is a schematic configuration diagram illustrating a construction elevator according to a third embodiment example.

FIG. 10 illustrates a method of extending a main rope in the construction elevator according to the third embodiment example and is a diagram illustrating a state in which a second machine room is moving.

FIG. 11 illustrates the method of extending the main rope in the construction elevator according to the third embodiment example and is a diagram illustrating a state in which a first machine room is moving.

FIG. 12 illustrates a method of extending a compensating rope in the construction elevator according to the third embodiment example and is a diagram illustrating a state after a machine room unit moves.

FIG. 13 is a schematic configuration diagram illustrating a construction elevator according to a fourth embodiment example.

### DESCRIPTION OF EMBODIMENTS

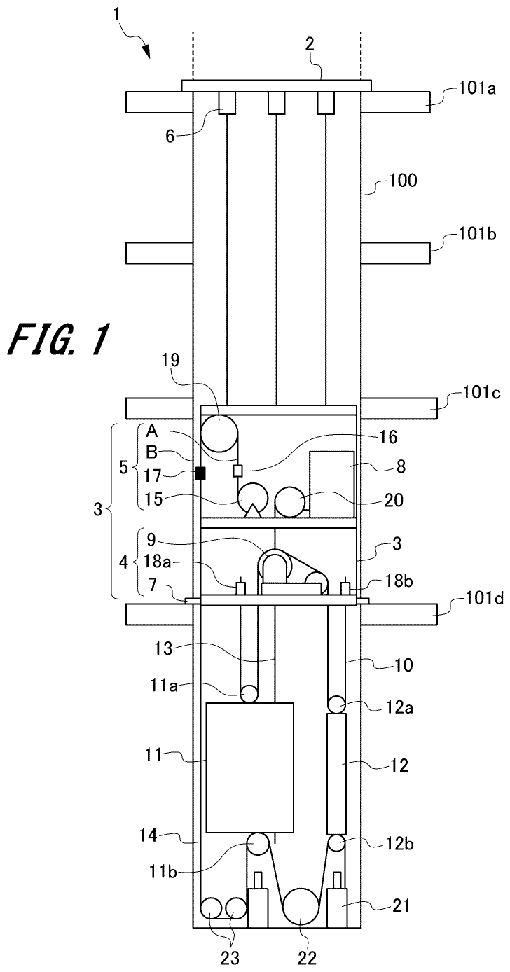

Hereinafter, with reference to FIGS. 1 to 13, construction elevators and methods of extending a main rope according to embodiment examples will be described. Note that the same reference signs are given to common members in the respective drawings.

### 1. First Embodiment Example

### 1-1. Configuration Example of Construction Elevator

First, with reference to FIG. 1, a configuration of a construction elevator according to a first embodiment example (hereinafter, referred to as “the present example”) will be described.

FIG. 1 is a schematic configuration diagram illustrating the construction elevator according to the present example.

The elevator illustrated in FIG. 1 is a construction elevator provided in a building structure under construction and used for transporting materials and people. As illustrated in FIG. 1, a construction elevator 1 includes a support member 2 disposed above a hoistway 100 of a building structure, a machine room unit 3, and a lifting machine 6 that lifts the machine room unit 3. In addition, the construction elevator 1 includes a hoisting machine 9, a main rope 10, a car 11 that carries people and materials, a counterweight 12, a compensating rope 14, and a pulley 19.

Each of the car 11 and the counterweight 12 illustrates an example of a rising/lowering unit. Note that a positional relationship between the car 11 and the counterweight 12 may be reversed. In other words, in FIG. 1, a counterweight may correspond to reference sign 11, and a car may correspond to reference sign 12. Hereinafter, a direction in which the car 11 and the counterweight 12, which are rising/lowering units, rise and lower is defined as a vertical direction.

The car 11 includes a car-side pulley 11a and a car-side compensating pulley 11b. The car-side pulley 11a is provided above the car 11, and the car-side compensating pulley 11b is provided below the car 11. The counterweight 12 includes a weight-side pulley 12a and a weight-side compensating pulley 12b. A weight-side pulley 11a is provided above the counterweight 12, and the weight-side compensating pulley 12b is provided below the counterweight 12.

The main rope 10 is wound around a car-side pulley 10a and the weight-side pulley 12a. The main rope 10 is wound around a sheave of the hoisting machine 9 provided in the machine room unit 3 to be described later. Moreover, both ends of the main rope 10 are fixed to the machine room unit 3 by rope fixing units 18a and 18b. In other words, one end of the main rope 10 is fixed to the rope fixing unit 18a and is wound around the car-side pulley 10a, the hoisting machine 9, and the weight-side pulley 12a in this order. Furthermore, the other end of the main rope 10 is fixed to the rope fixing unit 18b provided in the machine room unit 3. Furthermore, the hoisting machine 9 is driven, whereby the car 11 and the counterweight 12 rise and lower in the hoistway 100.

In addition, the compensating rope 14 is wound around the car-side compensating pulley 11b of the car 11 and the weight-side compensating pulley 12b of the counterweight 12. Note that a detailed configuration of the compensating rope 14 will be described later.

Moreover, a buffer 21 and lower pulleys 22 and 23 are provided in a pit that is a lower part of the hoistway 100 in the vertical direction. The buffer 21 is disposed below the car 11 and the counterweight 12 in the vertical direction. The compensating rope 14 is wound around the lower pulleys 22 and 23.

The support member 2 is provided on a beam 101a provided at the uppermost portion of the hoistway 100 or on a recess provided in a wall surface of the hoistway 100. The support member 2 is provided with the lifting machine 6. The machine room unit 3 is disposed below the support member 2 in the vertical direction. Furthermore, the machine room unit 3 is suspended from the support member 2 via the lifting machine 6. The machine room unit 3 is supported by the lifting machine 6 in a manner such that the machine room unit 3 can be lifted (moved). Note that the lifting machines 6 may be provided in a first machine room 4 and a second machine room 5 of the machine room unit 3 to be described later, and a lifting rope of the lifting machine 6 may be provided on the support member 2.

In addition, one lifting machine 6 of a plurality of lifting machines 6 is connected to the pulley 19 to be described later. Furthermore, the lifting machine 6 supports the pulley 19 in a manner such that the pulley 19 can be lifted (moved) in the vertical direction.

The machine room unit 3 includes the first machine room 4 and the second machine room 5. The first machine room 4 is disposed below the second machine room 5 in the vertical direction.

A movable support mechanism 7 is provided in a lower part of the first machine room 4 in the vertical direction. The movable support mechanism 7 is configured to be extendable and contractible from the first machine room 4 toward the wall surface of the hoistway 100. Furthermore, the movable support mechanism 7 is placed on beams 101b, 101c, and 101d provided in the hoistway 100 or on a recess provided in the wall surface of the hoistway 100. The movable support mechanism 7 supports the machine room unit 3 or the first machine room 4 at a predetermined position in the hoistway 100. Note that the movable support mechanism 7 is not limited to the one described above, and various other fixing mechanisms such as a guide rail that supports the car 11 in a manner such that the car 11 can rise and lower, an engagement member that engages with the wall surface of the hoistway 100, a fastening member that is fastened and fixed to the wall surface may be applied.

In the first machine room 4, the rope fixing units 18a and 18b that fix the ends of the main rope 10 are provided. Moreover, in the first machine room 4, the hoisting machine 9 is provided.

In the second machine room 5, a first rope-gripping device 16, a second rope-gripping device 17, a compensating-rope reel 15, a control panel 8, and a tail cord reel 20 are provided. The control panel 8 controls the hoisting machine 9, the car 11, and the like.

Furthermore, the control panel 8 and the car 11 are electrically connected via a tail cord 13. In addition, the tail cord reel 20 is provided in a vicinity of the control panel 8. The tail cord 13 for extension is wound around the tail cord reel 20. Furthermore, when the machine room unit 3 rises, the tail cord is drawn out from the tail cord reel 20.

The compensating rope 14 for extension is wound around the compensating-rope reel 15. Furthermore, when the machine room unit 3 is raised, the compensating rope 14 for extension is drawn out from the compensating-rope reel 15 via the pulley 19. Note that in the present example, an example in which the compensating-rope reel 15 is provided in the machine room unit 3 has been described, but the present example is not limited to this, and the compensating-rope reel 15 may be provided in the pit that is a lower part of the hoistway 100 or outside the hoistway 100.

In addition, during normal operation, the pulley 19 supported by the lifting machine 6 is disposed in the second machine room 5. The pulley 19 is disposed between the compensating-rope reel 15, the car 11 that illustrates the rising/lowering unit, and the counterweight 12 that illustrates the rising/lowering unit. The compensating rope 14 drawn out from the compensating-rope reel 15 is wound around the pulley 19. Furthermore, the pulley 19 changes a direction in which the compensating rope 14 extends from upward to downward.

As described above, the compensating rope 14 is wound around the compensating-rope reel 15 and is drawn out from the compensating-rope reel 15. Therefore, one end of the compensating rope 14 is fixed to the compensating-rope reel 15.

The compensating rope 14 is drawn out from the compensating-rope reel 15, the direction in which the compensating rope 14 extends is changed from upward to downward by the pulley 19, and the compensating rope 14 is wound around a first lower pulley 23 provided in the lower part of the hoistway 100. Furthermore, the compensating rope 14 is wound around the car-side compensating pulley 11b, a second lower pulley 22, and the weight-side compensating pulley 12b in this order via the first lower pulley 23. Furthermore, the other end of the compensating rope 14 extending from the weight-side compensating pulley 12b is fixed to the pit that is the lower part of the hoistway 100.

The first rope-gripping device 16 is provided between the compensating-rope reel 15 and the pulley 19. The first rope-gripping device 16 releasably grips the compensating rope 14 drawn out from the compensating-rope reel 15. In addition, the first rope-gripping device 16 grips the compensating rope 14 on a rope reel side (hereinafter, simply referred to as a “first side”) A with respect to the pulley 19 along the compensating rope 14. Furthermore, the first rope-gripping device 16 grips the compensating rope 14 to restrict the movement of the compensating rope 14.

In addition, the second rope-gripping device 17 is provided in a vicinity of the first rope-gripping device 16 and the pulley 19. The second rope-gripping device 17 is disposed on a side of the rising/lowering unit with respect to the pulley 19 along the compensating rope 14, that is, a side of the car 11 and the counterweight 12 (hereinafter, simply referred to as a second side) B. Similarly to the first rope-gripping device 16, the second rope-gripping device 17 releasably grips the compensating rope 14. Furthermore, the second rope-gripping device 17 grips the compensating rope 14 to restrict the movement of the compensating rope 14.

Note that in the drawings, a state in which the compensating rope 14 is gripped at the first rope-gripping device 16 and the second rope-gripping device 17 is illustrated by painting in black, and a state in which the compensating rope 14 is released at the first rope-gripping device 16 and the second rope-gripping device 17 is illustrated by painting in white and outlining in black.

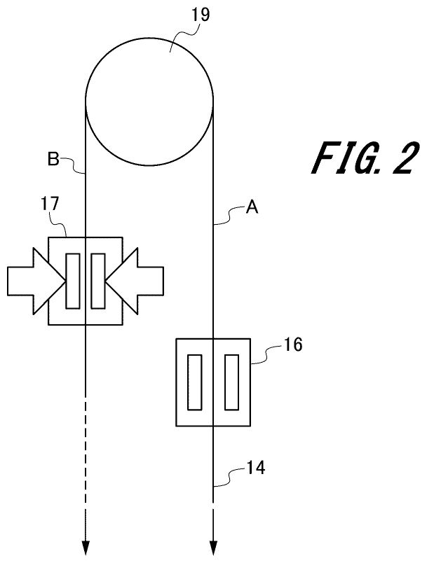

FIG. 2 is a diagram illustrating states of the first rope-gripping device 16 and the second rope-gripping device 17 during normal operation.

As illustrated in FIG. 2, during normal operation of the construction elevator 1, the first rope-gripping device 16 is released and the second rope-gripping device 17 operates to grip the compensating rope 14. Therefore, one end of the compensating rope 14 is fixed to the second rope-gripping device 17, and the other end of the compensating rope 14 is fixed to the pit of the hoistway 100.

Note that in the present example, an example in which the second rope-gripping device 17 grips the compensating rope 14 to fix the one end of the compensating rope 14 has been described, but the present example is not limited to this. For example, the second rope-gripping device 17 may be released and one end of the compensating rope 14 may be fixed by the first rope-gripping device 16. In addition, the compensating-rope reel 15, the first rope-gripping device 16, and the second rope-gripping device 17 may be disposed in the first machine room 4.

Note that in the construction elevator 1 of the present example, the machine room unit 3 has a two-story structure of the first machine room 4 and the second machine room 5. As a result, it is possible to reduce a horizontal space of the hoistway 100 that is occupied by the machine room unit 3. Note that the machine room unit 3 is not limited to the two-story structure and may have a one-story structure in which the control panel 8, the hoisting machine 9, the rope fixing units 18a and 18b, the compensating-rope reel 15, the first rope-gripping device 16, the second rope-gripping device 17, and the tail cord reel 20 are provided in one machine room. Moreover, the first machine room 4 and the second machine room 5 may be divided into two or more machine rooms.

### 1-2. Method of Extending Compensating Rope

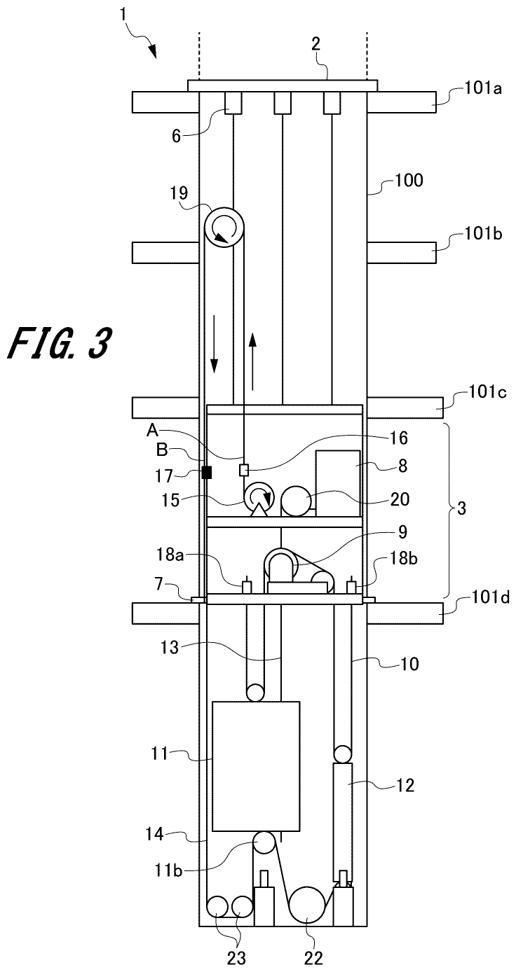

Next, with reference to FIGS. 3 to 7, a method of extending the compensating rope 14 in the construction elevator 1 having the above-described configuration, that is, a method of expanding an operation floor by raising the machine room unit 3 will be described.

FIGS. 3 to 7 are explanatory diagrams illustrating the method of extending the compensating rope 14.

First, as illustrated in FIG. 3, the counterweight 12 is lowered to the pit, and the counterweight 12 is placed on the buffer 21 provided in the pit. Next, in a manner similar to that during normal operation, the compensating rope 14 is gripped by the second rope-gripping device 17, and the gripping of the compensating rope 14 by the first rope-gripping device 16 is released.

Next, the lifting machine 6 connected to the pulley 19 is driven to raise only the pulley 19 to a predetermined height. At this time, the other end of the compensating rope 14, that is, the second side B with respect to the pulley 19 is fixed by the second rope-gripping device 17. In addition, a one end side of the compensating rope 14, that is, the first side A that is a side of the compensating-rope reel 15 is not fixed. Therefore, the compensating rope 14 can be drawn out from the compensating-rope reel 15 by raising the pulley 19. In addition, since the compensating rope 14 is folded back by the pulley 19, a length (height) by which the pulley 19 is raised is a length that is approximately a half of the extension of the compensating rope 14.

When the pulley 19 is moved, one end of the compensating rope 14 is fixed by the second rope-gripping device 17 provided in the machine room unit 3. Therefore, the compensating rope 14 is not drawn out downward in the vertical direction from the first machine room 4 of the machine room unit 3. As a result, even during the movement of the pulley 19, the hoisting machine 9 can be driven and the car 11 can be used.

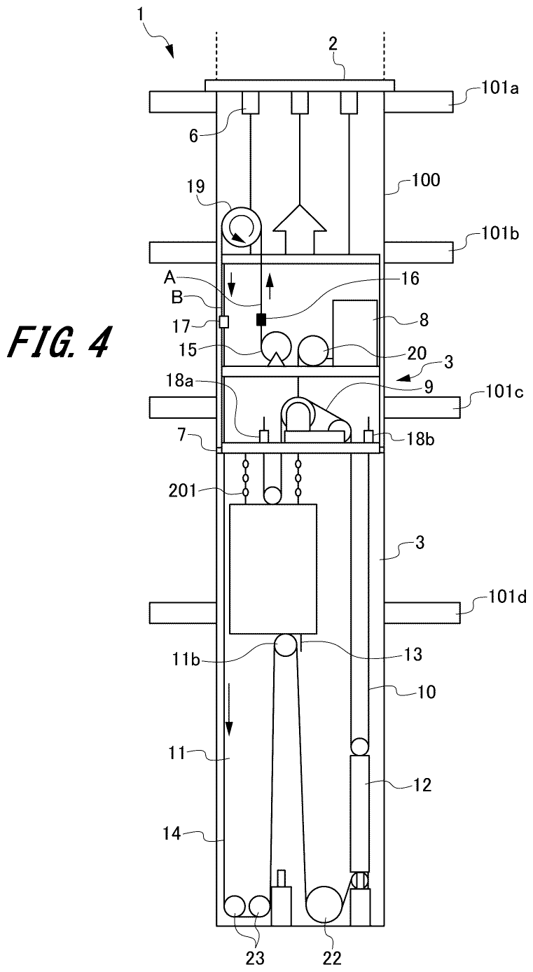

Next, as illustrated in FIG. 4, the car 11 and the machine room unit 3 are connected to each other by a chain 201. Note that the work of connecting between the car 11 and the machine room unit 3 may be performed before the work of raising the pulley 19.

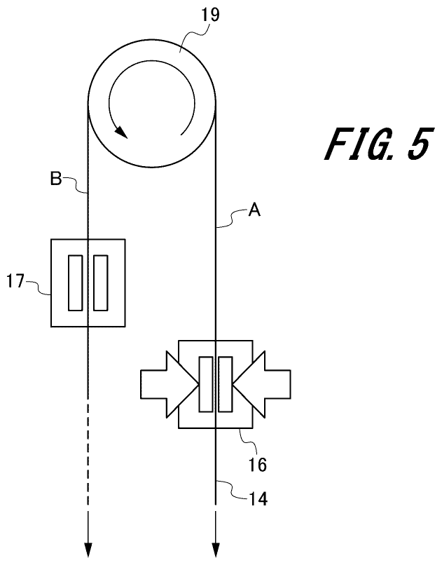

When the work of connecting between the car 11 and the machine room unit 3 is completed, as illustrated in FIG. 5, the compensating rope 14 is gripped by the first rope-gripping device 16, and the gripping of the compensating rope 14 by the second rope-gripping device 17 is released. Therefore, one end of the compensating rope 14 is fixed to the first rope-gripping device 16, and the other end of the compensating rope 14 is fixed to the pit of the hoistway 100.

Next, as illustrated in FIG. 4, the movable support mechanism 7 is contracted to release the support of the machine room unit 3 by the movable support mechanism 7.

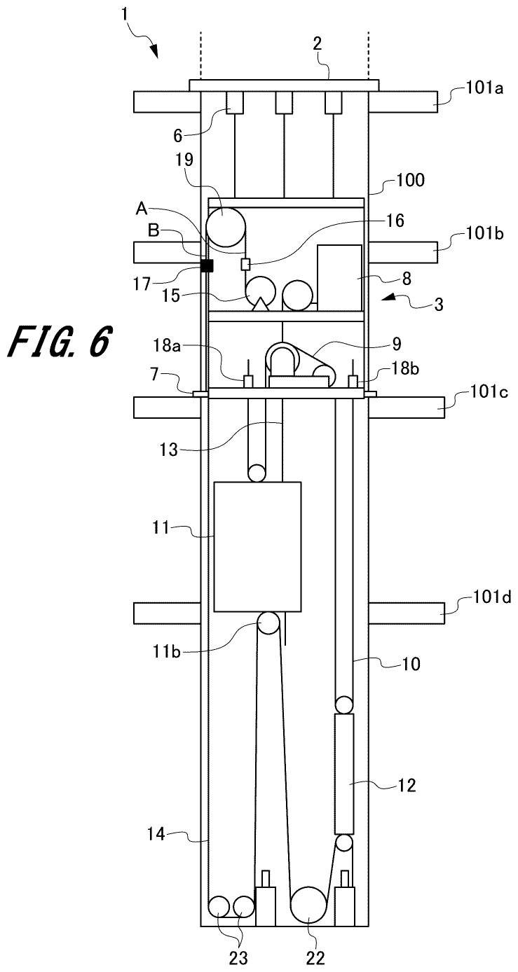

Furthermore, the lifting machine 6 connected to the machine room unit 3 is driven to raise the machine room unit 3 to a predetermined height (beam 101c in examples illustrated in FIGS. 4 and 6). As a result, the compensating rope 14 for extension drawn out from the compensating-rope reel 15 in operation illustrated in FIG. 3 is sent out to the side of the car 11 and the counterweight 12 via the pulley 19 and the second rope-gripping device 17.

When the machine room unit 3 rises to the predetermined height, as illustrated in FIG. 6, the driving of the lifting machine 6 is stopped and the movable support mechanism 7 is extended to place the movable support mechanism 7 on the beam 101c. As a result, the machine room unit 3 can be raised to the predetermined height.

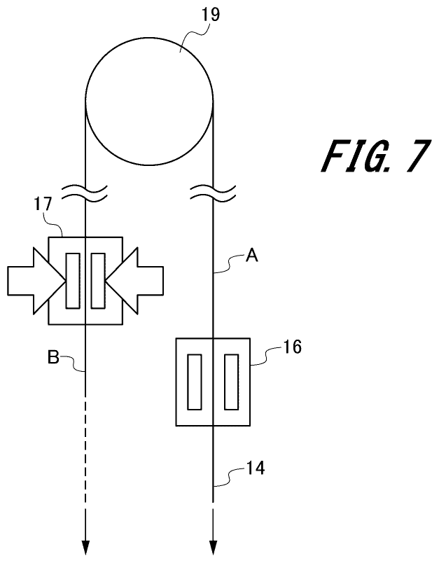

Next, as illustrated in FIGS. 6 and 7, the compensating rope 14 is gripped by the second rope-gripping device 17. As a result, the compensating rope 14 can be prevented from being drawn out from the compensating-rope reel 15 due to a weight of the compensating rope 14. In addition, the gripping of the compensating rope 14 by the first rope-gripping device 16 is released. Furthermore, a connection between the car 11 and the machine room unit 3 is released, and the counterweight 12 is pulled up from the buffer 21. By performing steps described above, the work of extending the compensating rope 14 and work of expanding the operation floor of the construction elevator 1 are completed.

According to the construction elevator 1 and the method of extending the compensating rope 14 of the present example, the work of extending the compensating rope 14 can also be performed at the same time along with the lifting of the machine room unit 3. As a result, the work of extending the compensating rope 14 can be easily performed, and time required for the work of expanding the operation floor of the construction elevator 1 can be reduced.

Moreover, the compensating rope 14 can be extended without sliding the compensating rope 14 on the first rope-gripping device 16 or the second rope-gripping device 17. As a result, wear of the compensating rope 14 can be prevented, and gripping force of the rope-gripping devices 16 and 17 can be easily adjusted.

### 2. Second Embodiment Example

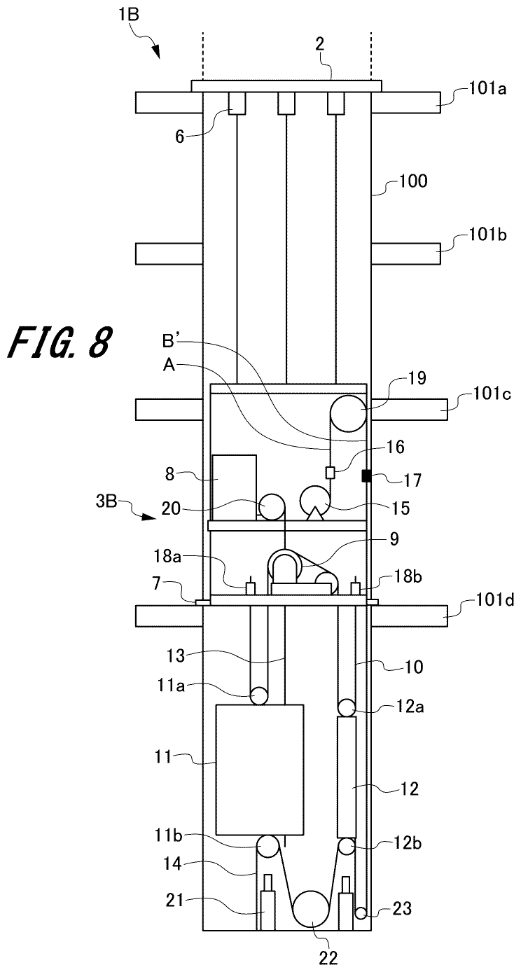

Next, with reference to FIG. 8, a construction elevator according to a second embodiment example will be described.

FIG. 8 is a schematic configuration diagram illustrating the construction elevator according to the second embodiment example.

The construction elevator according to the second embodiment example is different from the construction elevator according to the first embodiment example in terms of order in which a compensating rope is stretched over a car and a counterweight. Therefore, here, the same reference signs are given to parts in common with the construction elevator 1 according to the first embodiment example, and redundant description will be omitted.

As illustrated in FIG. 8, a construction elevator 1B includes a machine room unit 3B, a car 11, a counterweight 12, and a pulley 19. In the machine room unit 3B, a compensating-rope reel 15, a hoisting machine 9, a control panel 8, a first rope-gripping device 16, a second rope-gripping device 17, and the like are disposed.

In the construction elevator 1B according to the second embodiment example, a compensating rope 14 is drawn out from the compensating-rope reel 15 to the pulley 19 and wound around a weight-side compensating pulley 12b, a second lower pulley 22, and a car-side compensating pulley 11b in this order via a first lower pulley 23. Furthermore, the other end of the compensating rope 14 extending from the car-side compensating pulley 11b is fixed to a pit of a hoistway 100.

The second rope-gripping device 17 is disposed between the pulley 19 and the first lower pulley 23 along the compensating rope 14. Furthermore, the second rope-gripping device 17 releasably grips the compensating rope 14 on a side of a rising/lowering unit with respect to the pulley 19 along the compensating rope 14, that is, a side of the counterweight 12 (hereinafter, simply referred to as a second side) B′.

Other configurations are similar to those of the construction elevator 1 according to the first embodiment example, and thus the description thereof will be omitted. Also with the construction elevator 1B according to the second embodiment example, it is possible to obtain effects similar to those of the construction elevator 1 according to the first embodiment example described above.

### 3. Third Embodiment Example

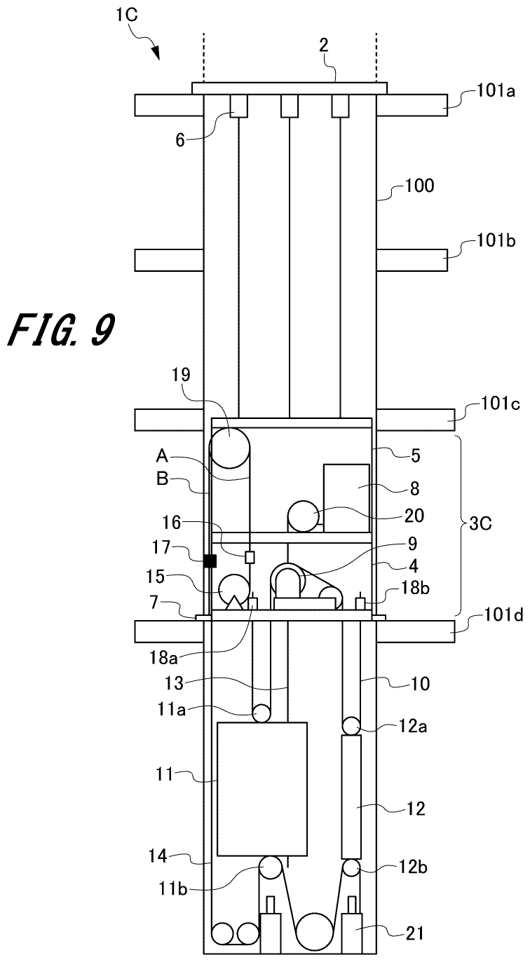

Next, with reference to FIGS. 9 to 12, a construction elevator according to a third embodiment example will be described.

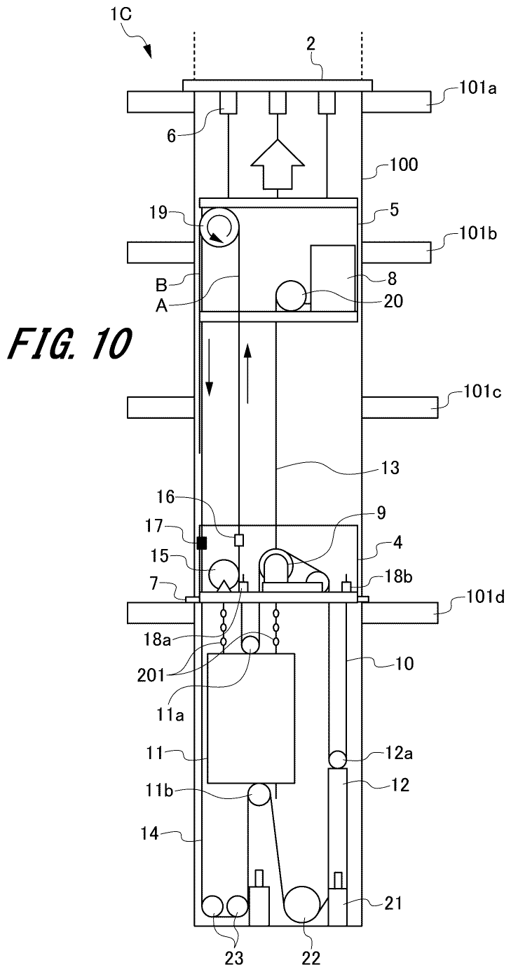

FIG. 9 is a schematic configuration diagram illustrating the construction elevator according to the second embodiment example, and FIGS. 10 to 12 are diagrams illustrating a method of extending a compensating rope in the construction elevator according to the second embodiment example.

The construction elevator according to the third embodiment example is different from the construction elevator 1 according to the first embodiment example in terms of a configuration of a machine room unit. Therefore, here, the same reference signs are given to parts in common with the construction elevator 1 according to the first embodiment example, and redundant description will be omitted.

As illustrated in FIG. 9, a construction elevator 1C includes a machine room unit 3C including a first machine room 4 and a second machine room 5. The second machine room 5 is placed on an upper part of the first machine room 4 in a vertical direction. Furthermore, the first machine room 4 and the second machine room 5 are separably connected to each other and are each independently lifted by a lifting machine 6.

A hoisting machine 9, rope fixing units 18a and 18b, a compensating-rope reel 15, a first rope-gripping device 16, and a second rope-gripping device 17 are disposed in the first machine room 4. Furthermore, a movable support mechanism 7 is provided in a lower part of the first machine room 4.

In the second machine room 5, a control panel 8, a tail cord reel 20, and a pulley 19 are provided. In addition, the pulley 19 is rotatably supported by the second machine room 5. Furthermore, the pulley 19 is lifted in the vertical direction together with the second machine room 5 along with the lifting operation of the second machine room 5.

A compensating rope 14 wound around the compensating-rope reel 15 is drawn out to the pulley 19 provided in the second machine room 5. Furthermore, the first rope-gripping device 16 is disposed between the compensating-rope reel 15 and the pulley 19 in the first machine room 4 and releasably grips a first side A of the compensating rope 14.

The compensating rope 14 folded back downward in the vertical direction by the pulley 19 passes through the first machine room 4 from the second machine room 5. Furthermore, the second rope-gripping device 17 is disposed at a part where the compensating rope 14 in the first machine room 4 extends downward in the vertical direction. Furthermore, the second rope-gripping device 17 releasably grips a second side B of the compensating rope 14. Note that the second rope-gripping device 17 may be provided in the second machine room 5.

During normal operation of the construction elevator 1C, the first rope-gripping device 16 is released, and the second rope-gripping device 17 grips the second side B of the compensating rope 14. Therefore, one end of the compensating rope 14 is fixed to the second rope-gripping device 17, and the other end of the compensating rope 14 is fixed to the pit of the hoistway 100. Note that the first rope-gripping device 16 may grip the first side A of the compensating rope 14 and the second rope-gripping device 17 may be released.

Next, with reference to FIGS. 10 to 12, a method of extending the compensating rope 14 of the construction elevator 1C according to the third embodiment example will be described.

As illustrated in FIG. 10, when the work of extending the compensating rope 14 is performed, first, a car 11 and the first machine room 4 are connected by a chain 201 and the car 11 is fixed. In addition, a counterweight 12 is lowered to the pit, and the counterweight 12 is placed on a buffer 21 provided in the pit. As a result, tension from the car 11 and the counterweight 12 is not applied to the compensating rope 14.

Next, the compensating rope 14 is gripped by the second rope-gripping device 17, and the gripping of the compensating rope 14 by the first rope-gripping device 16 is released. Note that in a case where the first rope-gripping device 16 grips the compensating rope 14, the gripping of the compensating rope 14 by the first rope-gripping device 16 is released. Furthermore, the first machine room 4 and the second machine room 5 are divided.

Next, the lifting machine 6 connected to the second machine room 5 is operated to raise only the second machine room 5 to a predetermined height (beam 101b in an example illustrated in FIG. 10). Note that since the compensating rope 14 is folded back by the pulley 19, a length (height) by which the second machine room 5 is raised is approximately half a length of the extension of the compensating rope 14. The second machine room 5 rises, whereby the pulley 19 provided in the second machine room 5 also rises. When the second machine room 5 rises to the predetermined height, the lifting machine 6 is stopped, and the second machine room 5 and the pulley 19 are temporarily fixed using the lifting machine 6, a second machine room support mechanism (not illustrated), or the like.

Here, the other end of the compensating rope 14 is fixed by the second rope-gripping device 17, but a one end side of the compensating rope 14, that is, a side of the compensating-rope reel 15 is not fixed. Therefore, along with the rising of the second machine room 5 and the pulley 19, the compensating rope 14 on the side of the compensating-rope reel 15 is pulled, and the compensating rope 14 for extension is drawn out from the compensating-rope reel 15. As a result, the rising operation of the second machine room 5 and the pulley 19 and the operation of drawing out the compensating rope 14 from the compensating-rope reel 15 can be performed at the same time.

When the second machine room 5 is moved, one end of the compensating rope 14 is fixed by the second rope-gripping device 17 provided in the first machine room 4. Therefore, the compensating rope 14 is not drawn out downward in the vertical direction from the first machine room 4. As a result, even during the movement of the second machine room 5, the hoisting machine 9 can be driven to use the car 11.

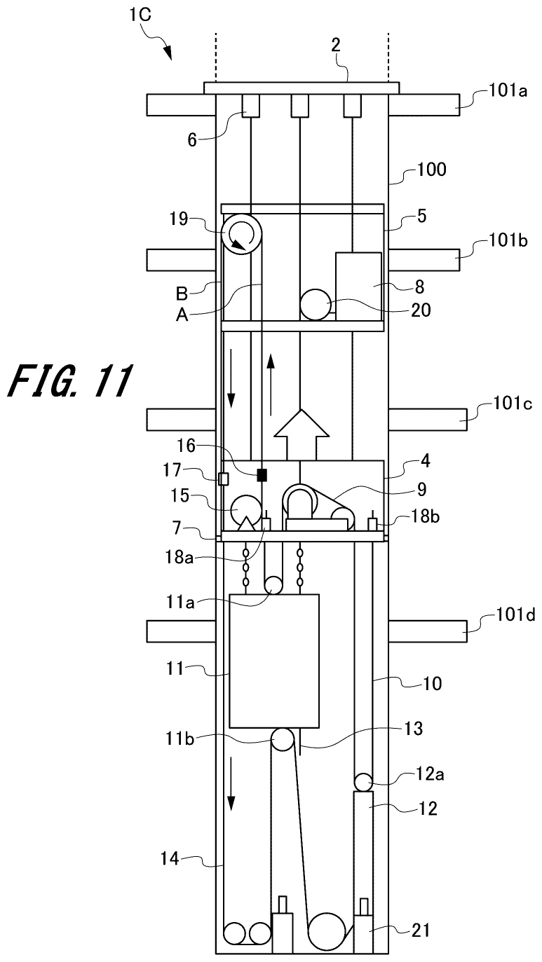

Next, as illustrated in FIG. 11, the compensating rope 14 is gripped by the first rope-gripping device 16, and the gripping of the compensating rope 14 by the second rope-gripping device 17 is released. In addition, for this reason, the other end of the compensating rope 14 is fixed to the pit of the hoistway 100, and one end of the compensating rope 14 is fixed to the first rope-gripping device 16.

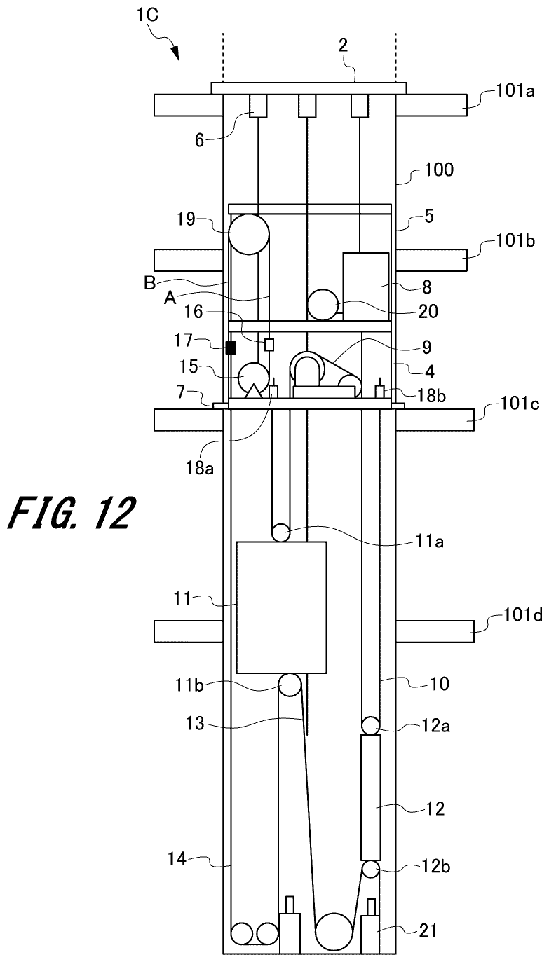

Next, the movable support mechanism 7 is contracted to release the support of the first machine room 4 by the movable support mechanism 7. Furthermore, the lifting machine 6 connected to the first machine room 4 is operated to raise the first machine room 4 to a predetermined height (beam 101c in examples illustrated in FIGS. 11 and 12). As a result, the compensating rope 14 for extension drawn out from the compensating-rope reel 15 in operation illustrated in FIG. 10 is sent out to the counterweight 12 and the car 11 via the pulley 19 and the second rope-gripping device 17.

When the first machine room 4 rises to the predetermined height, the lifting machine 6 is stopped. Furthermore, as illustrated in FIG. 12, the movable support mechanism 7 is extended to place the movable support mechanism 7 on the beam 101c. In addition, the first machine room 4 and the second machine room 5 are connected to each other. As a result, the machine room unit 3C including the first machine room 4 and the second machine room 5 can be raised to a predetermined height.

Next, as illustrated in FIG. 12, the compensating rope 14 is gripped by the second rope-gripping device 17. As a result, the compensating rope 14 can be prevented from being drawn out from the compensating-rope reel 15 due to a weight of the compensating rope 14. In addition, the gripping of the compensating rope 14 by the first rope-gripping device 16 is released. Furthermore, a connection between the car 11 and the machine room unit 3C is released, and the counterweight 12 is pulled up from the buffer 21. By performing steps described above, the work of extending the compensating rope 14 and work of expanding the operation floor of the construction elevator 1 are completed.

In addition, the machine room unit 3C is divided into the first machine room 4 and the second machine room 5, and the first machine room 4 and the second machine room 5 are each independently lifted. As a result, a weight applied to the lifting machine 6 can be reduced, and the lifting machine 6 can be prevented from increasing in size.

Other configurations are similar to those of the construction elevator 1 according to the first embodiment example, and thus the description thereof will be omitted. Also with the construction elevator 1C according to the third embodiment example, it is possible to obtain effects similar to those of the construction elevator 1 according to the first embodiment example described above.

### 4. Second Embodiment Example

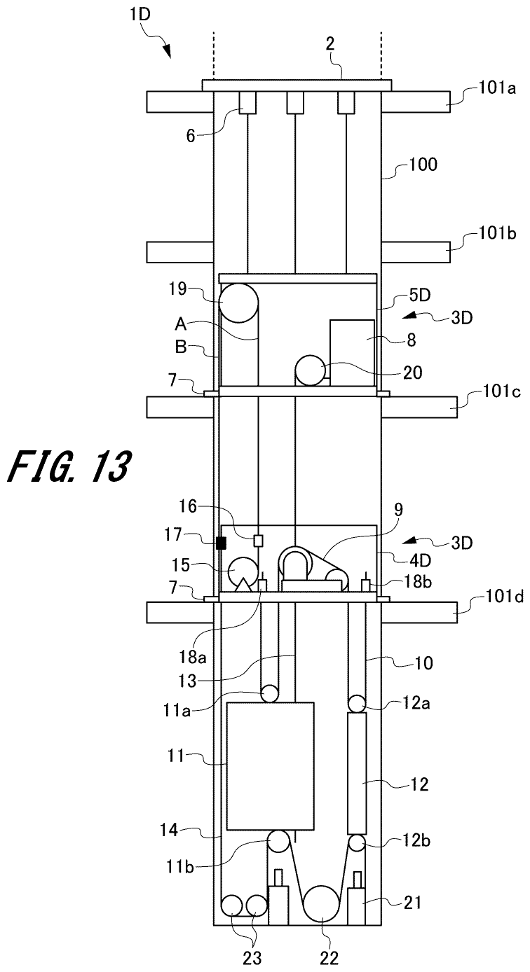

Next, with reference to FIG. 13, a construction elevator according to a fourth embodiment example will be described.

FIG. 13 is a schematic configuration diagram illustrating the construction elevator according to the fourth embodiment example.

The construction elevator according to the fourth embodiment example is one obtained by providing a movable support mechanism 7 also in the second machine room 5 of the construction elevator 1C according to the third embodiment example. Therefore, here, the same reference signs are given to parts in common with the construction elevator 1 according to the first embodiment example and the construction elevator 1C according to the third embodiment example, and redundant description will be omitted.

As illustrated in FIG. 13, a construction elevator 1D includes a machine room unit 3D including a first machine room 4D and a second machine room 5D. A hoisting machine 9, rope fixing units 18a and 18b, a compensating-rope reel 15, a first rope-gripping device 16, and a second rope-gripping device 17 are disposed in the first machine room 4D. Furthermore, a movable support mechanism 7 is provided in a lower part of the first machine room 4.

In the second machine room 5D, a control panel 8, a tail cord reel 20, and a pulley 19 are provided. In addition, similarly to the first machine room 4D, a movable support mechanism 7 is provided in a lower part of the second machine room 5D in a vertical direction. Since a configuration of the movable support mechanism 7 provided in the second machine room 5D is similar to a configuration of the movable support mechanism 7 provided in the first machine room 4D, the description thereof will be omitted.

As illustrated in FIG. 13, during operation of the construction elevator 1D, the second rope-gripping device 17 operates to grip a second side B of the compensating rope 14, and the first rope-gripping device 16 is released. Therefore, one end of the compensating rope 14 is fixed to the second rope-gripping device 17, and the other end of the compensating rope 14 is fixed to the pit of the hoistway 100.

Note that also in the construction elevator 1D according to the fourth embodiment example, the second rope-gripping device 17 may be released, the compensating rope 14 may be gripped by the first rope-gripping device 16, and the one end of the compensating rope 14 may be fixed by the first rope-gripping device 16.

In addition, in the construction elevator 1D according to the fourth embodiment example, the movable support mechanism 7 is provided also in the second machine room 5D. Therefore, as illustrated in FIG. 13, the first machine room 4D can be provided on a beam 101d, and the second machine room 5D can be provided on a beam 101c provided above a beam 101d in the vertical direction. As described above, in the construction elevator 1D according to the fourth embodiment example, the first machine room 4D and the second machine room 5D can be provided at different positions.

As a result, a height at which the second machine room 5D is provided can be changed in a state in which the hoisting machine 9 provided in the first machine room 4D is driven to cause the car 11 to rise and lower. Therefore, it is possible to perform the work of drawing out the compensating rope 14 from the compensating-rope reel 15 at the same time while operating the construction elevator 1D normally. As a result, during the work of drawing out the compensating rope 14, the work of drawing out the compensating rope 14 can be performed without stopping the rising and lowering operation of the car 11, and work efficiency can be improved.

Other configurations are similar to those of the construction elevator 1 according to the first embodiment example, and thus the description thereof will be omitted. Also with the construction elevator 1D according to the fourth embodiment example, it is possible to obtain effects similar to those of the construction elevator 1 according to the first embodiment example and the construction elevator 1C according to the third embodiment example described above.

Note that the present invention is not limited to embodiments described above and illustrated in the drawings, and various modifications can be made without departing from the gist of the invention described in the claims.

In the present specification, terms such as “parallel” and “orthogonal” have been used. However, these terms “parallel” and “orthogonal” do not mean only strict “parallel” and strict “orthogonal”, respectively. The term “parallel” may include a meaning of being “parallel” and also a meaning of being “substantially parallel” in a range in which the function can be exhibited. The term “orthogonal” may include a meaning of being “orthogonal” and also a meaning of being “substantially orthogonal” in a range in which the function can be exhibited.

The number of compensating ropes is not limited to one, and a plurality of compensating ropes may be provided. Furthermore, a plurality of first rope-gripping devices and a plurality of second rope-gripping devices are provided according to the number of compensating ropes. Moreover, a plurality of first rope-gripping devices and a plurality of second rope-gripping devices may be provided for one compensating rope.

### Reference Signs List

1, 1B, 1C, 1D Construction elevator
2 Support member
3, 3B, 3C, 3D Machine room unit
4, 4D First machine room
5, 5D Second machine room
6 Lifting machine
7 Movable support mechanism
8 Control panel
9 Hoisting machine
10 Main rope
11 Car (rising/lowering unit)
11a Car-side pulley
11b Car-side compensating pulley
12 Counterweight (rising/lowering unit)
12a Weight-side pulley
12b Weight-side compensating pulley
13 Tail cord
14 Compensating rope
15 Compensating-rope reel
16 First rope-gripping device
17 Second rope-gripping device
19 Pulley
20 Tail cord reel
100 Hoistway
101a, 101b, 101c, 101d Beam

1. A construction elevator comprising:
a compensating-rope reel around which a compensating rope is wound;
a rising/lowering unit around which the compensating rope drawn out from the compensating-rope reel is wound, the rising/lowering unit being configured to rise and lower in a hoistway of a building structure;
a pulley that is disposed between the compensating-rope reel and the rising/lowering unit along the compensating rope and around which the compensating rope drawn out from the compensating-rope reel is wound;
at least one or more first rope-gripping devices that releasably grip the compensating rope on a side of the compensating-rope reel with respect to the pulley; and
at least one or more second rope-gripping devices that releasably grip the compensating rope on a side of the rising/lowering unit with respect to the pulley, wherein
the pulley is movably supported along a rising/lowering direction of the rising/lowering unit.

2. The construction elevator according to claim 1, further comprising:
a machine room unit provided with a hoisting machine that raises and lowers the rising/lowering unit; and
a lifting machine that supports the machine room unit in a manner such that the machine room unit can be lifted.

3. The construction elevator according to claim 2, wherein
the pulley is lifted independently of the machine room unit.

4. The construction elevator according to claim 2, wherein
the pulley is rotatably supported by the machine room unit and is lifted together with the machine room unit.

5. The construction elevator according to claim 2, wherein
the machine room unit is divided into a plurality of machine rooms.

6. The construction elevator according to claim 5, wherein
the machine room unit includes:
a first machine room provided with the first rope-gripping device and the second rope-gripping device; and
a second machine room disposed on an upper part of the first machine room in a vertical direction, the second machine room being provided with the pulley.

7. A method of extending a compensating rope of a construction elevator including: a compensating-rope reel around which a compensating rope is wound; a rising/lowering unit around which the compensating rope drawn out from the compensating-rope reel is wound, the rising/lowering unit being configured to rise and lower in a hoistway of a building structure; a pulley that is disposed between the compensating-rope reel and the rising/ lowering unit along the compensating rope and around which the compensating rope drawn out from the compensating-rope reel is wound; a first rope-gripping device that releasably grips the compensating rope on a side of the compensating-rope reel with respect to the pulley; and a second rope-gripping device that releasably grips the compensating rope on a side of the rising/lowering unit with respect to the pulley, the method comprising:
a step of gripping the compensating rope by the second rope-gripping device;
a step of releasing gripping of the compensating rope by the first rope-gripping device, raising the pulley to a predetermined height along a rising/lowering direction of the rising/lowering unit, and drawing out the compensating rope from the compensating-rope reel;
a step of, after raising the pulley to the predetermined height, gripping the compensating rope by the first rope-gripping device and releasing gripping of the compensating rope by the second rope-gripping device; and
a step of raising a machine room unit provided with the second rope-gripping device to a predetermined height.
